(19) United States
(12) Patent Application Publication
(10) Pub. No.: US 2024/0170681 A1
(43) Pub. Date: May 23, 2024

(54) ELECTRODE STRUCTURE AND ITS MANUFACTURING METHOD AND BATTERY STRUCTURE INCLUDING THE SAME

(71) Applicant: National Cheng Kung University, Tainan (TW)

(72) Inventors: KUAN-ZONG FUNG, Tainan (TW); SHU-YI TSAI, Tainan (TW)

(21) Appl. No.: 18/510,995

(22) Filed: Nov. 16, 2023

(30) Foreign Application Priority Data
Nov. 17, 2022 (TW) 111143981

(51) Int. Cl. H01M 4/80; H01M 4/02

(52) U.S. Cl. CPC H01M 4/80; H01M 2004/021; H01M 2300/0065

(57) ABSTRACT

An electrode structure used for a solid-state battery comprises a conductive structure and an electrode material, wherein the conductive structure comprises a conductor and a plurality of continuous pores formed on the conductor, and the conductor exhibits both of electronic conduction and ionic conduction materials. The electrode material comprises a plurality of active material particles, which are used to fill the continuous pores and in electrical contact with each other to form an electrical connection with the conductive structure. The manufacturing method of the electrode structure and its application in the battery structure are also disclosed.

### FIELD OF THE INVENTION

The present invention relates to an electrode structure, and particularly relates to an electrode structure that can improve charging and discharging efficiency and its manufacturing method and application.

### BACKGROUND OF THE INVENTION

In recent years, with the rapid development of portable electronic devices and electric vehicles, the demand for lithium-ion batteries with high power, high energy density and high heat resistance has also grown rapidly. Among them, solid-state lithium-ion batteries are expected to become a new generation equipment for storing energy.

In the existing technology, the electrode composition is composed of active material particles, conductive agents and binders evenly mixed. In terms of application, solid-state batteries have problems with dendrite formation and internal short circuits; sulfur or sulfur-containing organic compounds are highly insulating properties in electron and ion. In order to achieve reversible electrochemical reactions at high current densities or charge/discharge rates, sulfur must be in close contact with the conductive additives. Quite a variety of carbon-sulfur composite materials have been developed in conventional technology. However, given the limited internal contact area of the battery, the success rate of fast charging and discharging is quite low, and at medium charging and discharging rates, its capacity only falls below between 300 and 550 mAh/g. In addition, batteries using sulfur-containing, organic sulfur or carbon-sulfur materials as cathodes have a significant disadvantage. The soluble sulfides involved have excessive outward diffusion into the battery and its components. This is a problem known as the shuttle effect, which will lead to battery failure problems such as high self-discharge rate, electrode capacity loss, current collector and wire corrosion, resulting in ion transmission loss and a significant increase in battery internal resistance.

Solid-state batteries in conventional technologies often have significant capacity attenuation during charging and discharging cycles, which is mainly due to excessive interface resistance. Although polymers, gel electrolytes or the addition of a small amount of electrolyte can be used to improve the good adhesion between the electrolyte and the electrode. However, the safety of the battery will still be limited at high discharge rates and discharge depths. Furthermore, the electrode is a porous structure formed by stacking particles composed of active materials, conductive agents, binders and solvents, thus inhibiting the diffusion path of lithium ions, which making it relatively difficult to insert and extract lithium ions from the electrode, so as to significantly reduce the battery benefits.

Therefore, in view of the deficiencies in the prior art, the applicant of this invention finally conceived this invention after careful research and experimentation, and in the spirit of perseverance, overcoming the deficiencies of the prior art. The following is a brief description of this invention.

### SUMMARY OF THE INVENTION

One object of the present invention is to provide an electrode structure used for a solid-state battery comprising a conductive structure and an electrode material, wherein the conductive structure comprises a conductor and a plurality of continuous pores formed on the conductor, and the conductor is made of electronic conduction and ionic conduction materials. The electrode material comprises a plurality of active material particles, which are used to fill the continuous pores and in electrical contact with each other so as to form an electrical connection with the conductive structure.

As above-mentioned electrode structure, wherein the electronic conduction and ionic conduction materials comprise a plurality of conductive active particles, and the conductive active particles are stacked together to form the conductor and are in electrical contact with each other.

As above-mentioned electrode structure, wherein each of the continuous pores is a cylindrical channel, and the cylindrical channel passes through the conductor from one side to the other.

As above-mentioned electrode structure, wherein a relationship between the continuous pores and the length, width and height of the conductor is expressed as follows:

0.3≤(n×π×R²×H)/(L×W×H)≤0.6,

wherein n is the total number of these continuous pores; π is a ratio of a circumference of a circle to a diameter of the circle; R is the average radius of the cylindrical channel of the continuous pores; H is the height of the conductor; L is the length of the conductor; W is the width of the conductor.

As above-mentioned electrode structure, wherein the conductive structure has an average porosity of 30 to 60%.

As above-mentioned method, wherein the conductive structure has an average porosity of 30 to 40%.

As above-mentioned electrode structure, wherein the electrode structure includes an interface intermediate layer that is positioned on the conductive structure and covering the continuous pores, wherein the interface intermediate layer exhibits both electronic conductivity and ionic conductivity.

As above-mentioned electrode structure, wherein the components of the interface intermediate layer contain elements selected from the group consisting of lithium (Li), sodium (Na), titanium (Ti), lanthanum (La), nickel (Ni), aluminum (Al), strontium (Sr), barium (Ba), calcium (Ca), magnesium (Mg), cobalt (Co), manganese (Mn), iron (Fe) and a combination of two or more thereof.

Another object of the present invention is to provide a battery structure, comprising a positive electrode layer, a negative electrode layer and a solid electrolyte layer configured between the positive electrode layer and the negative electrode layer, wherein the positive electrode layer or the negative electrode layer comprises an electrode structure as described above.

Another object of the present invention is to provide a method for manufacturing an electrode structure, comprising: using an electronic conduction and ionic conduction material to form a conductive structure, wherein the conductive structure includes a conductor and multiple continuous pores formed on the conductor; and filling the continuous pores of the conductive structure with an electrode material, establishing an electrical connection with the conductive structure.

As above-mentioned method, wherein the electronic conduction and ionic conduction material comprises a plurality of conductive active particles.

As above-mentioned method, wherein the electrode material comprises a plurality of active material particles.

As above-mentioned method, wherein the step of using an electronic conduction and ionic conduction material to form a conductive structure comprises: stacking the conductive active particles to form the conductive structure; and sintering the conductive structure to make the conductive active particles connect to each other so as to form an integrated structure.

As above-mentioned method, wherein the step of filling the continuous pores of the conductive structure with an electrode material comprises: filling the active material particles in the continuous pores and electrically contacting each other; and sintering the active material particles to connect with the conductors of the conductive structure so as to form an electrical connection.

As above-mentioned method, further comprising: forming an interface intermediate layer on the conductive structure and covering the continuous pores, wherein the interface intermediate layer exhibits both electronic conductivity and ionic conductivity.

As above-mentioned method, wherein the components of the interface intermediate layer contain elements selected from the group consisting of lithium (Li), sodium (Na), titanium (Ti), lanthanum (La), nickel (Ni), aluminum (Al), strontium (Sr), barium (Ba), calcium (Ca), magnesium (Mg), cobalt (Co), manganese (Mn), iron (Fe) and a combination of two or more thereof.

As above-mentioned method, wherein each of the continuous pores is a cylindrical channel, and the cylindrical channel passes through the conductor from one side to the other.

As above-mentioned method, wherein a relationship between the continuous pores and the length, width and height of the conductor is expressed as follows:

0.3≤(n×π×R²×H)/(L×W×H)≤0.6,

wherein n is the total number of these continuous pores; π is a ratio of a circumference of a circle to a diameter of the circle; R is the average radius of the cylindrical channel of the continuous pores; H is the height of the conductor; L is the length of the conductor; W is the width of the conductor.

As above-mentioned method, wherein the conductive structure has an average porosity of 30 to 60%.

As above-mentioned method, wherein the conductive structure has an average porosity of 30 to 40%.

The electrode structure provided by the invention has the following advantages:

1. The electrode structure of the present invention has a plurality of continuous pores formed on the conductive structure and a porous structure formed by stacking a plurality of active material particles, so that lithium ions can not only use the continuous pores as transmission channels, but also it can shuttle through active material particles via pore structures so as to maximize bulk ionic conductivity.

2. By reconstructing the design of the electrode structure, the present invention can effectively solve the problem of the insertion and extraction process of lithium ions in the electrode, and maximize the specific surface area of the electrode itself. Thus, it can enable rapid charging and discharging, and make the specific capacitance be greatly improved compared with the conventional technology.

3. The present invention uses the interface intermediate layer to reduce the interface resistance. During discharge, lithium ions move from the negative electrode to the positive electrode through the solid electrolyte, which is conducted by utilizing the special conductivity of the lithium ions in passing through the interface intermediate layer and the conductive structure.

### BRIEF DESCRIPTION OF THE DRAWINGS

FIG. 1 is one schematic three-dimensional view of the appearance of an electrode structure of the present invention.

FIG. 2 is one schematic three-dimensional view of the appearance of the conductive structure of an electrode structure of the present invention.

FIG. 3 is another schematic three-dimensional view of the appearance of an electrode structure of the present invention.

FIG. 4A is a test chart of the voltage of the Au layer changing with time.

FIG. 4B is a test chart of the voltage change over time of the interface intermediate layer of the present invention.

FIG. 5 is a microstructure diagram of the electrode structure of the present invention under an electron microscope.

FIG. 6 is a schematic cross-sectional view of a battery structure of the present invention.

FIG. 7 is a schematic flow chart of a manufacturing method of an electrode structure according to the present invention.

### DETAILED DESCRIPTION OF THE INVENTION

The purpose of the present invention and its structural and functional advantages will be explained based on the structure shown in the following figures and with specific embodiments, so that the review committee can have a more in-depth and specific understanding of the present invention.

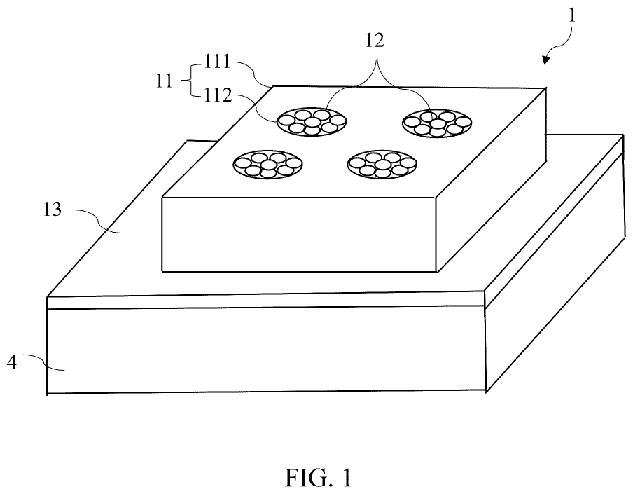

In order to achieve the above purpose, please refer to FIG. 1. One embodiment of the present invention is to provide an electrode structure 1 used for a solid-state battery, comprising a conductive structure 11 and an electrode material 12, wherein the conductive structure 11 comprises a conductor 111 and a plurality of continuous pores 112 formed on the conductor 111, and the conductor 111 is made of electronic conduction and ion conduction materials. The electrode material 12 comprises a plurality of active material particles, which are used to fill the continuous pores 112 and electrically contact each other so as to form an electrical connection with the conductor 111 of the conductive structure 11.

In this embodiment, the electronic conduction and ion conduction material used in the conductor 111 comprises a plurality of conductive active particles. The conductive active particles are stacked together to form the conductor 111 and are in electrical contact with each other. In order to stabilize the structure of the conductor 111 formed by stacking a plurality of conductive active particles, sintering can be used to make the conductive active particles connect to each other so as to form an integrated structure. For example, and without limitation, other methods such as conductive glue can also be used to connect the conductive active particles into the integrated structure in the present invention. Alternatively, the conductor 111 may also be a conductive structure formed by metal foam material or metal casting.

It can be understood that if the conductor 111 in the conductive structure 11 is in the form of a rectangular plate, as shown in FIG. 1, the plurality of continuous pores 112 formed on the conductor 111 can penetrate the upper and lower sides of the conductor 111. Because the upper and lower opposite sides of the conductor 111 are penetrated, a good ion channel can be provided to the electrode material 12. The electrode material 12 filled in the continuous pores 112 can smoothly allow ions to pass through the electrode structure 1, thereby speeding up the movement of ions. Therefore, the greater the porosity formed by the continuous pores 112 on the conductor 111 can induce the larger or more ion channels, which can result in better ion transmission effects. However, if the porosity is too large, the structural strength of the conductor 111 will be insufficient, and the conductive thickness or cross-section of the conductor 111 will become smaller, which will result in an increase in impedance. Therefore, the design of the porosity of the conductive structure 11 actually needs to be researched and verified so as to obtain the best and ideal results. In this embodiment, the conductive structure 11 has an average porosity of 30 to 40%. In some embodiments, the conductive structure 11 has an average porosity of 30 to 60%. By adjusting the porosity ratio of the conductive structure 11 in the electrode structure 1, batteries can be prepared in response to different current magnitudes and environments.

In addition, the continuous pore 112 can penetrate the conductor 111, and the best design of the channel of the continuous pore 112 is a cylindrical channel, which can make the filling resistance of the electrode material 12 filled in it be minimum when filling, so as to facilitate smooth filling of the electrode material 12, and the area in contact with the conductor 111 is the largest. Furthermore, the cylindrical channel passes through the conductor 111 in a straight line, so the ions released from the electrode material 12 can pass through the electrode structure 1 in a straight line through the cylindrical channel, thereby speeding up the ion transmission speed. In addition, a plurality of continuous pores 112 formed on the conductor 111 are arranged in a matrix. This design can obtain the most appropriate number, diameter and porosity of ion channels. Meanwhile, a sufficient structural strength and an impedance magnitude can be ensured so as to achieve optimal design. However, without limitation, the channel design of the continuous pore 112 does not have to be a cylindrical channel, and other shapes of designs can also be applied to the present invention.

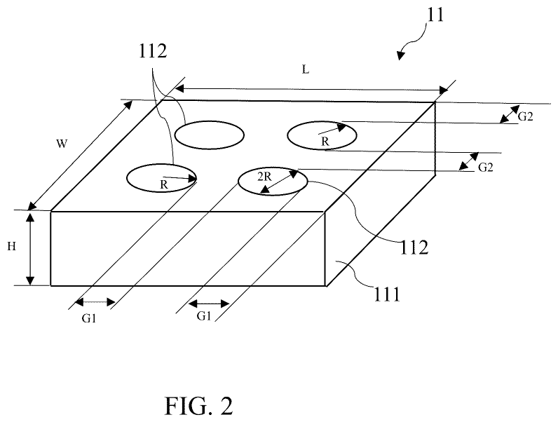

Specifically, please refer to FIG. 2, which is a three-dimensional schematic diagram of the conductive structure 11 of the present invention. It is generally a rectangular plate structure, and the continuous pores 112 formed therein are cylindrical channels. The volume of each cylindrical channel is π×radius squared (R²)×height (H), and the volume of conductor 111 is length (L)×width (W)×height (H). Therefore, the porosity is the ratio of the total volume of continuous pores 112 to the total volume of conductor 111, which must comply with a following relationship:

0.3≤(n×π×R²×H)/(L×W×H)≤0.6,

wherein n is the total number of the continuous pores 112; 7L is a ratio of a circumference of a circle to a diameter of the circle; R is the average radius of the cylindrical channel of the continuous pores 112; H is the height of the conductor 111; L is the length of the conductor 111; W is the width of the conductor 111.

It can be understood that when the distance between the two continuous pores 112 is regarded as equal to the distance between the continuous pore 112 and the edge of the conductor 111, then the length L of the conductor 111 can be regarded as the sum of the diameters of the two continuous holes 112 plus the distance G1 between the two continuous holes 112 and the edges of the two conductors 111 plus the distance G1 between the two continuous holes 112, and the width W of the conductor 111 can be regarded as the sum of the diameters of two continuous pores 112 plus the distance G2 between the two continuous holes 112 and the edges of the two conductors 111 plus the distance G2 between the two continuous pores 112, wherein if the length L of the conductor 111 is equal to the width W, the distance G1 is approximately equal to the distance G2. If the length L of the conductor 111 is greater than the width W, the distance G1 should be larger than the distance G2. Basically, the distance G1 and the distance G2 will be smaller than the diameter of the continuous pore 112. That is, G1<2R, and G2<2R. When the porosity is to be increased, the design of the distance G1 and the distance G2 will be smaller than the radius of the continuous pore 112. That is, G1<R, and G2<R.

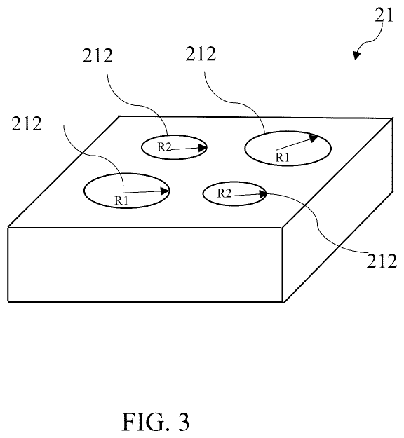

Please refer to FIG. 3, which is a three-dimensional schematic diagram of another conductive structure 21 of the present invention. It can be understood that the main difference between FIG. 3 and FIG. 2 is that the radiuses of all the pores 212 in FIG. 3 are not all exactly the same. There is a difference between the large radius R1 and the small radius R2, wherein the relationship is expressed as the small radius R2<radius R<large radius R1, and the average radius of the large radius R1 and the small radius R2 is approximately equal to the radius R. Basically, during actual manufacturing, the radius R of each pore 112 in FIG. 2 will be slightly different due to manufacturing tolerances, but the average radius R of the pores 112 can be used to calculate in actual use. As for the large radius R1 and the small radius R2 of the pore 212 in FIG. 3, they are intentionally designed to produce a relative difference in size. It can be understood that if the numerical difference between the large radius R1 and the small radius R2 in FIG. 3 and the radius R in FIG. 2 is not large, then the average radius obtained by the large radius R1 and the small radius R2 is used to calculate the total volume of the pore 212, which will be approximately close to the total volume of the pores 112 calculated by using the average radius R in FIG. 2.

In this embodiment, the electrode material 12 comprises a plurality of active material particles. The active material particles fill the continuous pores 112 and are in electrical contact with each other to form an electrical connection with the conductive structure 11. Similarly, in order to stabilize the structure of the electrode material 12 formed by stacking a plurality of active material particles, the active material particles can also be connected to each other integrally so as to form an integrated structure by sintering. However, this is not limited to this, other methods such as conductive glue can be used to connect the active material particles. The method of connecting these conductive active particles integrally into an integrated structure can also be used in the present invention. At the same time, you can also choose to add additional conductive additives to the electrode material 12 to increase the electronic conductivity of the electrode material 12.

It can be understood that the conductive structure 11 of the present invention is formed by stacking a plurality of conductive active particles, and the electrode material 12 is formed by stacking a plurality of active material particles. The electrode material 12 is filled in the multiple continuous pores 112 formed by the conductive structure 11, so the contact area between the electrode material 12 and the conductive structure 11 can be greatly increased, which can effectively maximize the specific surface area of the electrode and solve the problem of the limited contact area between the conductive additive and the electrolyte layer in the electrode, thereby enabling rapid charging and discharging. In addition, the active particles of the conductive structure 11 and the electrode material 12 are separately mixed and forming design, instead of the post mix forming design as the conventional technology, which not only avoids the problem of internal short circuit, but also maximizes the conductive path, so that a higher current density can be carried during fast charging and discharging process.

In addition, this electrode structure 1 is used in solid-state batteries. In order to increase the conductivity of electrons and ions at the contact interface between the solid electrolyte 4 and the electrode structure 1, an interface intermediate layer 13 is added on one side of the electrode structure 1. The interface intermediate layer 13 is disposed on the conductive structure 11 and covers the continuous pores 112, so that the interface intermediate layer 13 can contact the conductive structure 11 and the electrode material 12 at the same time, thereby forming good electronic conduction and ion conduction effects. Since the interface intermediate layer 13 is between the solid electrolyte 4 and the electrode structure 1 and has both electronic conductivity and ion conductivity, it can effectively improve the conductivity of electrons and ions at the contact interface between the solid electrolyte 4 and the electrode structure 1.

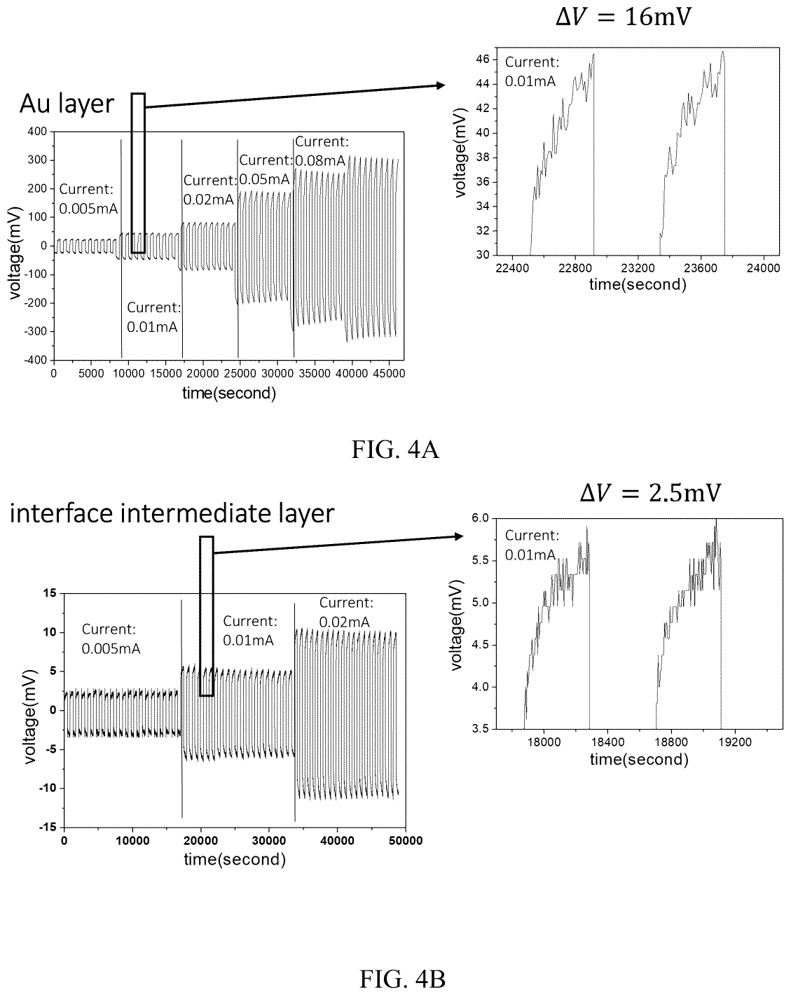

In this embodiment, the interface intermediate layer 13 is a thin film made of a material that can conduct electrons and ions, and its components comprise lithium (Li), sodium (Na), and titanium (Ti), lanthanum (La), nickel (Ni), aluminum (Al), strontium (Sr), barium (Ba), calcium (Ca), magnesium (Mg), cobalt (Co), manganese (Mn) and iron (Fe) and a combination of two or more thereof. In order to verify the degree of improvement in the conduction performance of the interface intermediate layer 13, the interface impedance reduction effect of the interface intermediate layer 13 and the gold layer (Au layer) is compared to each other. As shown in FIG. 4A and FIG. 4B, they are test charts of the voltage changes of the Au layer and the interface intermediate layer 13 with time respectively, to compare the difference in the effect of reducing impedance between the Au layer and the interface intermediate layer 13. Both of them simultaneously select the stage with a current of 0.01 mA as the comparison benchmark. The change of its voltage with time (the slope of the stage) means the difficulty of lithium-ion diffusion. The FIG. 4 A and FIG. 4B show that the change slope of using the Au layer is greater than that of using the interface intermediate layer 13, which means that the interface intermediate layer 13 transports lithium ions more easily than the gold layer. Therefore, the experimental test comparison of the interface resistance reduction between the Au layer and the interface middle layer 13 shows that the interface middle layer 13 with dual conductivity (electron and ion conductivity) has a lower interface impedance.

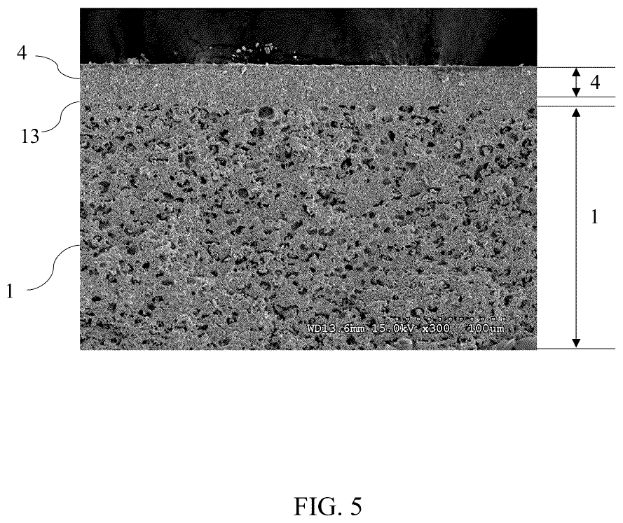

Please refer to FIG. 5, which is a microstructure diagram of the electrode structure 1 of the present invention under an electron microscope. It can be seen that the interface intermediate layer 13 is covered on the electrode structure 1 and located between the solid electrolyte 4 and the electrode structure 1, wherein the electrode structure 1 is a porous structure, which is conducive to ion conduction, and the interface intermediate layer 13 does not have pores. It is understandable that such a structure can easily lead to a lower interface impedance.

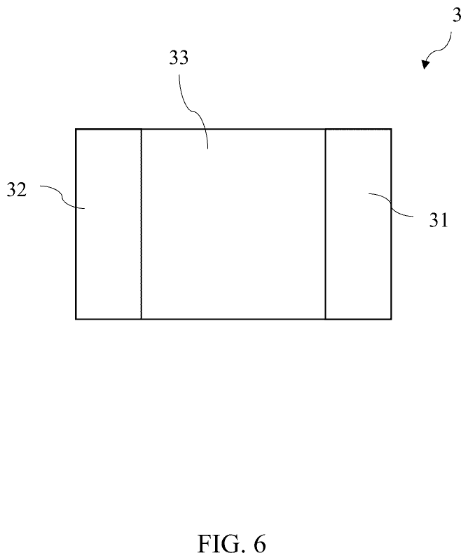

Referring to FIG. 6, the electrode structure 1 of the present invention is applied to a battery structure 3, such as a solid-state battery, and this battery structure 3 comprises: a positive electrode layer 31, a negative electrode layer 32, and a solid electrolyte layer 33 disposed between the positive electrode layer 31 and the negative electrode layer 32. The positive electrode layer 31 or the negative electrode layer 32 can optionally use the above-mentioned electrode structure 1 to improve the charging and discharging efficiency of the battery structure 3.

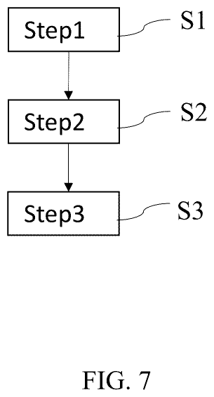

Referring to FIG. 7, the present invention provides a method for manufacturing an electrode structure, which comprises: Step 1 (S1): using an electronic conduction and ionic conduction material to form a conductive structure, wherein the conductive structure comprises a conductor and a plurality of continuous pores formed on the conductor; Step 2 (S2): filling the continuous pores of the conductive structure with an electrode material and establishing an electrical connection with the conductive structure; and Step 3 (S3): forming an interface intermediate layer on the conductive structure and covering the continuous pores, wherein the interface intermediate layer exhibits both electronic conductivity and ion conductivity, and the element contained in the composition of the interface intermediate layer is selected from the group consisting of lithium (Li), sodium (Na), titanium (Ti), lanthanum (La), nickel (Ni), aluminum (Al), strontium (Sr), barium (Ba), calcium (Ca), magnesium (Mg), cobalt (Co), manganese (Mn), iron (Fe) and a combination of two or more thereof.

In some embodiments, the electronic conduction and ionic conduction material comprises a plurality of conductive active particles, so the step of using the electronic conduction and ionic conduction material to form a conductive structure may also comprise: stacking the conductive active particles to form the conductive structure with a plurality of continuous pores; and sintering the conductive structure to make the conductive active particles connect to each other integrally so as to form an integrated structure.

In some embodiments, the electrode material comprises a plurality of active material particles. Therefore, the step of filling the continuous pores of the conductive structure with the electrode material may also comprise: filling the active material particles in the continuous pores and electrically contacting with each other; and sintering the active material particles to connect with the conductors of the conductive structure so as to form an electrical connection. It can be understood that since the material of the active material particles is different from the aforementioned conductive active particles, the sintering temperature and time of the two active particles are different. In addition, the interface intermediate layer formed on the conductive structure can contact the conductor and the electrode material. Because it has electronic conductivity and ion conductivity, it can form electronic conduction with the conductor and form ionic conduction with the electrode material, thereby increasing the conduction rate. In other embodiments, the interface intermediate layer can optionally be connected to an additional conductive path so as to increase an additional conductive path, thereby increasing the conduction speed.

The electrode structure designed by the present invention avoids internal short circuit problems since the electrode structure itself is composed of active materials. Because the conductive path is maximized, it can carry higher current density during rapid charging and discharging.

The electrode structure of the present invention maximizes the specific surface area of the electrode itself through the conductive architecture design with continuous pores so as to solve the problem of the limited contact area between the conductive additive and the electrolyte layer in the electrode. This design not only enables rapid charging and discharging, but also make the specific capacitance be greatly improved compared with the conventional technology.

The present invention uses the interface intermediate layer to reduce the interface resistance. During discharging, lithium ions move from the negative electrode to the positive electrode through the solid electrolyte and use the special conductivity of the interface intermediate layer to conduct lithium ions. Its composition avoids the use of organic solvents, thereby eliminating the problem of organic solvents dissolving reaction intermediates, such as lithium sulfide ions, so as to reduce the loss of active materials in the electrode. Thus, the loss of electrode capacity can slow down and the risk of internal corrosion of the battery caused by the sulfide dissolution and diffusion can reduce.

It is to be understood that the foregoing descriptions of the embodiments are given by way of example only, and various modifications may be made by those skilled in the art to which this field pertains. The above specification and examples provide a complete description of the flow of exemplary embodiments of the invention and their uses. Although the above embodiments disclose specific embodiments of the present invention, they are not intended to limit the present invention. Those with ordinary knowledge in the technical field to which the present invention pertains, without departing from the principle and spirit of the present invention, can make various changes and modifications to it, so the protection scope of the present invention should be defined by the appended claims.

What is claimed is:

1. An electrode structure used for a solid-state battery, comprising:
a conductive structure, wherein the conductive structure comprises a conductor and a plurality of continuous pores formed on the conductor, and the conductor is made of electronic conduction and ionic conduction materials; and
an electrode material, wherein the electrode material comprises a plurality of active material particles, which are used to fill the continuous pores and in electrical contact with each other so as to form an electrical connection with the conductive structure.

2. The electrode structure as claimed in claim 1, wherein the electronic conduction and ionic conduction materials comprise a plurality of conductive active particles, and the conductive active particles are stacked together to form the conductor and are in electrical contact with each other.

3. The electrode structure as claimed in claim 1, wherein each of the continuous pores is a cylindrical channel, and the cylindrical channel passes through the conductor from one side to the other.

4. The electrode structure as claimed in claim 3, wherein a relationship between the continuous pores and the length, width and height of the conductor is expressed as follows:
0.3≤(n×π×R²×H)/(L×W×H)≤0.6,
wherein n is the total number of the continuous pores; π is a ratio of a circumference of a circle to a diameter of the circle; R is the average radius of the cylindrical channel of the continuous pores; H is the height of the conductor; L is the length of the conductor; W is the width of the conductor.

5. The electrode structure as claimed in claim 1, wherein the conductive structure has an average porosity of 30 to 60%.

6. The electrode structure as claimed in claim 1, wherein the conductive structure has an average porosity of 30 to 40%.

7. The electrode structure as claimed in claim 1, wherein the electrode structure includes an interface intermediate layer that is disposed on the conductive structure and covering the continuous pores, wherein the interface intermediate layer exhibits both electronic conductivity and ionic conductivity.

8. The electrode structure as claimed in claim 7, wherein the components of the interface intermediate layer contain elements selected from the group consisting of lithium (Li), sodium (Na), titanium (Ti), lanthanum (La), nickel (Ni), aluminum (Al), strontium (Sr), barium (Ba), calcium (Ca), magnesium (Mg), cobalt (Co), manganese (Mn), iron (Fe) and a combination of two or more thereof.

9. A battery structure, comprising:
a positive electrode layer;
a negative electrode layer; and
a solid electrolyte layer, configured between the positive electrode layer and the negative electrode layer, wherein the positive electrode layer or the negative electrode layer comprises an electrode structure according to claim 1.

10. A method for manufacturing an electrode structure, comprising:
Step1: using an electronic conduction and ionic conduction material to form a conductive structure, wherein the conductive structure includes a conductor and multiple continuous pores formed on the conductor; and
Step2: filling the continuous pores of the conductive structure with an electrode material, establishing an electrical connection with the conductive structure.

11. The method as claimed in claim 10, wherein the electronic conduction and ionic conduction material comprises a plurality of conductive active particles.

12. The method as claimed in claim 10, wherein the electrode material comprises a plurality of active material particles.

13. The method as claimed in claim 10, wherein the step of using the electronic conduction and ionic conduction material to form the conductive structure comprises: stacking the conductive active particles to form the conductive structure; and sintering the conductive structure to make the conductive active particles connect to each other so as to form an integrated structure.

14. The method as claimed in claim 10, wherein the step of filling the continuous pores of the conductive structure with an electrode material comprises: filling the active material particles in the continuous pores and electrically contacting each other; and sintering the active material particles to connect with the conductors of the conductive structure so as to form an electrical connection.

15. The method as claimed in claim 10, further comprising:
Step3: forming an interface intermediate layer on the conductive structure and covering the continuous pores, wherein the interface intermediate layer exhibits both electronic conductivity and ionic conductivity.

16. The method as claimed in claim 15, wherein the components of the interface intermediate layer contain elements selected from the group consisting of lithium (Li), sodium (Na), titanium (Ti), lanthanum (La), nickel (Ni), aluminum (Al), strontium (Sr), barium (Ba), calcium (Ca), magnesium (Mg), cobalt (Co), manganese (Mn), iron (Fe) and a combination of two or more thereof.

17. The method as claimed in claim 10, wherein each of the continuous pores is a cylindrical channel, and the cylindrical channel passes through the conductor from one side to the other.

18. The method as claimed in claim 17, wherein a relationship between the continuous pores and the length, width and height of the conductor is expressed as follows:
0.3≤(n×π×R²×H)/(L×W×H)≤0.6,
wherein n is the total number of these continuous pores; π is a ratio of a circumference of a circle to a diameter of the circle; R is the average radius of the cylindrical channel of the continuous pores; H is the height of the conductor; L is the length of the conductor; W is the width of the conductor.

19. The method as claimed in claim 10, wherein the conductive structure has an average porosity of 30 to 60%.

20. The method as claimed in claim 10, wherein the conductive structure has an average porosity of 30 to 40%.
